(19) United States
(12) Patent Application Publication
(10) Pub. No.: US 2025/0161811 A1
(43) Pub. Date: May 22, 2025

(54) Artificial Intelligence Platform for Player Tracking, Researching, and Selection

(71) Applicant: Heavy Inc., Clermont, NY (US)

(72) Inventors: Simon Assaad, Far Hills, NJ (US); Aaron Nobel, Rhinebeck, NY (US)

(21) Appl. No.: 18/943,653

(22) Filed: Nov. 11, 2024

Related U.S. Application Data
(60) Provisional application No. 63/601,013, filed on Nov. 20, 2023.

(51) Int. Cl. A63F 13/533; A63F 13/537

(52) U.S. Cl. CPC A63F 13/533; A63F 13/537

(57) ABSTRACT

A fantasy sports artificial intelligence platform, configured to use the techniques of artificial intelligence (AI) and large language model (LLM) in providing assistance to users in tracking, researching and choosing players to form their lineups of players (e.g., virtual teams of real-world players) in participation of a simulated game.

### RELATED APPLICATIONS

The present application claims priority to Prov. U.S. Pat. App. Ser. No. 63/601,013 filed Nov. 20, 2023, the entire disclosures of which application are hereby incorporated herein by reference.

### TECHNICAL FIELD

At least some embodiments disclosed herein relate to artificial intelligence, and simulated games.

### BACKGROUND

Fantasy sport is a type of simulated games. A user or participant of such a game can select a lineup of real-world players as a virtual team to participate in a virtual/simulated competition against other lineups or virtual teams. The performance of players in the virtual/simulated competition can be randomly generated according to simulation based on statistical real-world performance of the players, or based on actual performance of the players in real-world sports events mapped to the virtual/simulated competition according to predetermined rules. There can be rewards and/or costs for the users or participants of the simulated game based on the results of the virtual/simulated competition among the lineups or virtual teams selected by the users or participants.

Artificial intelligence has been used to power chat robots, or chatbots, to communicate with users in natural language to provide information. For example, ChatGPT operated by OpenAI and Bard operated by Google are powered by the techniques of large language models to, in response to chat inputs from users, analyze the topic of the chat inputs and generate chat responses in a way simulating a person with knowledge in the topic in responding to the users.

### BRIEF DESCRIPTION OF THE DRAWINGS

The embodiments are illustrated by way of example and not limitation in the figures of the accompanying drawings in which like references indicate similar elements.

FIG. 1 shows an artificial intelligence platform configured to assist users in tracking, researching, and selecting players in simulated games according to one embodiment.

FIG. 2 shows a method implemented in an artificial intelligence platform according to one embodiment.

FIG. 3 a block diagram of an example computer system in which embodiments of the present disclosure can be implemented.

### DETAILED DESCRIPTION

At least one embodiment disclosed herein provides a fantasy sports artificial intelligence platform. Such a platform is configured to use the techniques of artificial intelligence (AI) and large language model (LLM) in providing assistance to users in tracking, researching and choosing players to form their lineups of players (e.g., virtual teams of real-world players) in participation of a simulated game.

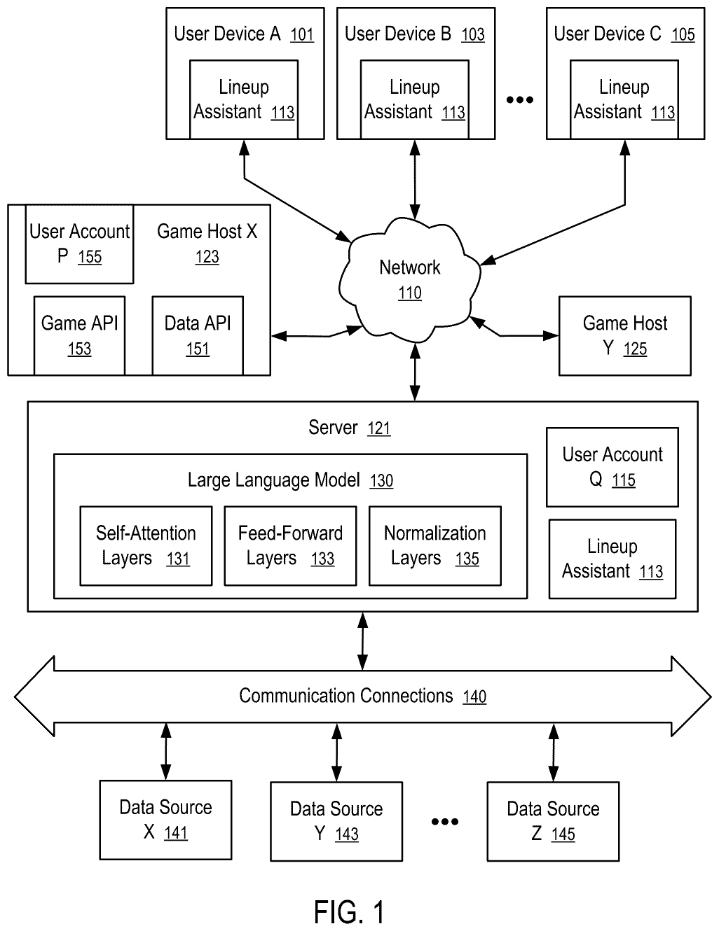

FIG. 1 shows an artificial intelligence platform configured to assist users in tracking, researching, and selecting players in simulated games according to one embodiment.

The platform can include a server 121 configured to pull from data sources (e.g., 141, 143, . . . , 145) over communication connections 140 and through application programming interface (API) feeds (e.g., 151) to obtain up-to-the minute information, including player statistics, player projections, injury reports, depth charts, and player news.

The platform can include a large language model 130 trained at least in part using the information pulled from at least some of the data sources. The large language model 130 can have self-attention layers 131, feed-forward layers 133, and normalization layers 135 stacked together and trained to understand natural language inputs (e.g., chats in text and/or voice) from users about their lineups. The large language model 130 uses the techniques of positional encodings and self-attention to train artificial neural networks to analyze, in subtle ways, contexts of conversations in which distinct elements influence and relate to each other over long distances and non-sequentially.

The server 121 is configured to use the large language model 130 to identify relevant information of interest to the users based on their chat inputs, present the relevant information, suggest lineups, adjust lineups in response to user instructions, and present lineups to the users and/or to hosts of simulated games on behalf of the users.

The platform can provide a mobile-friendly interface (e.g., implemented as lineup assistants 113 in user devices 101, 103, . . . , 105). For example, a user device (e.g., 101) can be a mobile phone, a tablet computer, a personal media player, a notebook computer, a personal computer, etc. A user can use the interface provided by the lineup assistant to request, save, and edit lineups, export the lineups to fantasy sports providers (e.g., 123, 125), track players, and customize strategies for entering the lineups in competitions in the simulated games.

A sports enthusiast may research players (e.g., athletes) through written content and editorial, historical athlete and position data, athlete projections, current game day conditions and use their judgment to manually identify players (e.g., athletes) in a spreadsheets to create lineups for daily fantasy and season long fantasy sports competitions.

Typically, sports fans create these lineups by using their judgment to pick athletes which they believe have the highest probability of winning and in aggregate are at or under the salary cap prescribed by the daily fantasy rules for the competition for which they submit the lineup. Such a process is time consuming. The current incarnation of fantasy sports requires participants to have a strong understanding of risk and return outcomes for athletes, as well as a deep understanding of athlete standings and possible impacts on their performance week by week based on real-time news, historical information and data, and a complete understanding of the rules for each daily and season long fantasy competitions, of which there are hundreds. The existing daily fantasy tools and resources are scattered in different locations and are often geared towards desktop users.

The fantasy sports artificial intelligence platform as in FIG. 1 can communicate with a user via a chat interface. After the user initiates a chat with an app (e.g., running on a mobile device, such a smartphone or a tablet computer, such as a user device 101), the app (e.g., lineup assistant 113) makes a call to the large language model (LLM) 130 to determine if a question from the user requires external data. If the large language model (LLM) determines that an answer to the question from the user requires external data, the app and/or the server 121 can retrieve the data from one or more relevant data sources using application programming interfaces (e.g., 151) of the data sources (e.g., game host 123 or other data sources 141, 143, . . . , 145). The retrieved data can be supplied as context to a subsequent call to the large language model (LLM) 130, which generates an answer to the question from the user. Optionally, the user may request the app to build a lineup; and in response, the app can visually display the lineup (e.g., a virtual team of players with thumbnail/representative images the players), in additional to a textual representation of the lineup. Optionally, the user may request the app to enter the lineup to a competition; and the app can communicate with a provider of a simulated game (e.g., a fantasy sports game) via an application programming interface to enter the lineup for the user.

The fantasy sports artificial intelligence platform as in FIG. 1 can generate lineups, and identify and provide information relevant to the lineups to users on the major sports, including NFL, NBA, NHL and MLB, along with more niche sports, including UFC, tennis, WNBA, college sports and golf.

Such a platform can democratize the knowledge base, automates risk assessment and lineup generation, can be accessible anywhere on any device, e.g., via a mobile phone user interface experience, unshackling fantasy participants from their desktop computers. As artificial intelligence chip evolution moves from servers to phones, the platform can work locally on the phone instead of back to the server.

Such a platform can provide an artificial intelligence application programmed to learn to become an expert at creating daily and season long fantasy sports lineups. The application can be trained using content feeds (e.g., from data sources 141, 143, . . . , 145) of historical and projected sports data, athlete and team news and AI-powered performance projections and through the continued interaction with user requests and conversations. The platform can make public what content feeds are being used.

The platform can be configured to pull information from the daily fantasy sports competition providers (e.g., game hosts 123, 125). The platform can cache data obtained from the application programming interface (API) feeds of content partners (e.g., hosts 123 and 125 over a network 110, and partner data sources 141, 143, 145 over connections 140). The cached data can allow for quick and accurate responses; and the platform can learn from user queries and conversations.

The artificial intelligence application can be programmed with various conversational short-cuts, referred to as prompts. A prompt is a pre-programmed conversation that is labeled with a word or phrase to enable users to get to answers faster and to train the large language model of the platform on what information users most require.

The artificial intelligence application can be programmed to present information in both a conversational syntax in a chat interface and also provide key information elements including historical player data, player projection data, daily fantasy game rules and daily fantasy lineups in a web user interface configured as part of the application (e.g., lineup assistant 113 running in the server 121). The user communicates with the application through the conversational interface and/or through the mobile-friendly web user interface. The platform can recognize input from both interfaces equally and concurrently.

A user makes requests of the platform with regard to sports and fantasy sports using a natural language (e.g., in text or voice). The platform provides users with a list of prompts. Prompts are language short cuts which the platform has been programmed to understand as a series of commands and language which generate a specific query and answer.

For example, the user choosing to make a lineup using the platform may first designate on which game provider/host (e.g., host 123) they will be playing fantasy sports, such as DraftKings, FanDuel, YahooFantasy etc. The platform retrieves information via the application programming interface (API) of the game provider/host and provides the user with a list of available competitions for that day or other time period or date the user is interested in.

The user may choose one or more competitions to generate lineups for, request the rules from the application, and request the application to generate a lineup for a specific competition.

The platform can deploy a pre-programmed multi-lineup generator (e.g., a lineup assistant 113 implemented in the server 121 and/or a device 101 of the user) to create one or more lineups using competition parameters including available athletes, positions, salary caps and points per player. For example, the generator can be programmed to generate randomly lineups according to the constraints of the competition and user requirements, and predict the performance of the lineups to identify a lineup that is most likely to win within the parameters prescribed by the competition and the user. If the user does not prescribe parameters, the platform can generate the lineup with the highest likelihood of success based on running thousands of scenarios and choosing the most likely outcome within the rules proscribed by the daily fantasy competition provider (e.g., game host 123).

The user can optionally override the platform in lineup generation by specifying either through the chat interface, the web interface or voice commands with regard to athlete positions, selection, and/or other aspects of the configuration of a lineup. The user may use multiple interfaces of different types concurrently; and the different interfaces provided to the user are seamlessly synced so that changes in one interface are reflected in the other.

When a lineup is generated by the platform, the lineup can appear in the output window. The output window allows the user to X out (remove) a player from the lineup, which then sends a message to the platform to change the lineup per the user instructions. In response to seeing that the player has been X'ed out, the platform can ask the user if they want a brand new lineup with that player now excluded, or the optimized lineup that was created by the AI but replacing just the player the user has now identified for exclusion. For example, the AI lineup includes Patrick. Since the user decides they don't want Patrick in their lineup via X'ing out Patrick. The platform can create a lineup with another player replacing Patrick and the remaining players that are identified in the previous lineup, or create a whole new lineup that does not include Patrick and optically does not include one or more other players identified in the previous lineup by switching out one or more other players. Optionally, the user may instruct the platform to keep one or more identified players in the next lineup to be generated by the platform.

Optionally, the user may request additional information from the application that may impact their lineup choices.

Examples of such additional information can include parameters that impact the platform's choice of players for a lineup, such as weather, location of game, risk parameters which will include player ownership (e.g., the number of other game participants that have a specific player in a lineup) and likelihood of outcome.

The lineup optimizer can be configured to work smoothly on a mobile device, including the conversational aspect and the data output. This will enable users to do everything in one place: research players, optimize a lineup, make changes to lineups and then export them.

Once the user has finalized a lineup, they can save it to their own database inside the interface of the platform. If parameters for a player change prior to the fantasy competition running, the platform can contact the user, inform them of the change, and ask them if they want to change their lineup(s).

Once the user has finalized on the platform their lineups for a competition, they may download the lineups as a file (e.g., in a CSV format or another format) to upload to the fantasy competition provider/host, or they may log into the fantasy competition provider/host directly from the platform/mobile application, linking their accounts (e.g., 155 and 115) and upload their lineups from the platform into the provider/host seamlessly via application programming interfaces (e.g., 153).

The platform can use the sports information feeds, including AI-powered projections, and feeds from top sportsbooks to power an AI betting assistant. The betting features can include odds and line information, odds shopping, parlay and bet builders/analysis.

The assistant can be configured to analyze projections and win probabilities to help the user build parlays, which are when two or more bets are combined to increase the odds in a single bet. The parlay builder will find spots where the projections and probabilities show an increased likelihood of a successful bet. The assistant can send alerts on line movements, provide advice on strategies and track bets and past performance to help a bettor understand what they could do to improve. The parlay builder and assistant can be conversational, powered by the large language model.

The line shopper aspect of the assistant can use the large language model as an artificial intelligence brain to find the best lines available on the market at a given time and alert the user to those lines.

In one embodiment, the platform includes a lineup optimizer controlled by a large language model 130. The large language model 130 can be configured as a user interface or a human-machine interface, to obtain commands in a natural language to define the parameters of a request to generate a lineup for a virtual competition. For example, the user can ask, via chat messages and/or voice inputs, the lineup optimizer to “include Patrick” and “exclude Christian” from their lineup; and the large language model 130 can understand the request and run the lineup optimizer to generate a lineup that has Patrick included and Christian excluded.

Similarly, a parlay maker can be controlled by the large language model 130 determining the parameters for making a parlay for a user.

Further, the large language model 130 can be configured as a reasoner on data that is extracted and aggregated from multiple data sources (e.g., 141, 143, . . . , 145), such as unstructured data from newsfeeds and articles for optimizing a lineup and/or making a parlay.

In one embodiment, a chat bot powered by the large language model 130 is configured to understand the language and vernacular of daily fantasy sports and sports betting.

A natural language with domain-specific terms used by fantasy sports gamers and sports bettors on various resources (e.g., forums, social media, chats) related to fantasy sports and betting can be captured via a glossary of fantasy sports and betting terms. The glossary can be attached and used to train the large language model 130 such that the large language model 130 can understand terms that are used in the context of the fantasy sports games and betting but not used in generic contexts. For example, a dataset can be collected and semi-manually prepared to train the large language model 130 such that the large language model 130 can understand the language and vernacular of daily fantasy sports and sports betting.

The platform powered by the large language model 130 can be configured to limit pulling data from a limited types of data sources (e.g., content, news, and data feeds within a walled garden of proprietary daily fantasy sports and sports betting).

For example, the question of “what is my exposure” in a generic context would likely lead to an answer related to the weather. However, the large language model 130 knows that the “exposure” mentioned in the platform is about the amount of money or bankroll that the user wagered and thus can provide the relevant answer accordingly. In some implementations, the large language model 130 is trained in the language and vernacular of daily fantasy sports and sports betting.

The large language model 130 can be trained ahead of time on a glossary of terms used in fantasy sports games and betting to understand the language specific to the fantasy sports games and betting. Further, the large language model 130 is trained to respond to real-time feeds and real-time requests that may impact fantasy projections and betting lineups in real-time. The large language model 130 can be trained to analyze the request/parameters of a user to identify additional relevant information pulled from data sources (e.g., a game host 123 or 125), use the additional information as a context to optimize a lineup and/or a parlay.

The platform can be configured to monitor lineups or parlays to provide notifications. For example, an artificial intelligence (AI) engine can be configured (e.g., via the large language model 130) to predict significant lineup or parlay changes due to structured or unstructured data changes in the data sources (e.g., 141, 143, . . . , 145 and game hosts 123, . . . , 125). The data changes can be collected via application programming interfaces (e.g., 151) and/or newsfeeds. In response to the data changes, the AI engine can determine updated results of lineup/parlay optimization. When the update results deviate from the prior results, the platform can notify the users when there is a variance outside the pre-determined risk tolerance.

For example, the platform can be configured to monitor any lineups or parlays that a user generates and saves and to detect changes to player status, odds lines, performance projections, and other information relevant to the risk and decisions made during the generation of the lineup or parlay. The platform can provide personalized notifications through email, push notification or alert, text, voicemail or other form of communication alert of those changes in real-time.

Based on the collected conversations data, the AI engine can be configured to recommend suitable prompts to follow the conversation and request additional information to improve the lineup. Prompts created by the platform are based on data collected and semi-manually prepared to train the large language model 130. Such custom prompts can direct the platform to access conversations and execute specific tasks to provide immediate answer to queries that are contextually relevant and accurate and execute tasks in the chat interface, lineup optimizer and parlay maker. Such prompts are a unique way to provide users an efficient and intuitive way to navigate conversations and tasks that are relevant to daily fantasy sports and sports betting. The creation of custom prompts combined with proprietary content feeds creates an interface contextualized for daily fantasy and sports betting to provide custom content, player comparisons, lineup generation, parlay generation, points, odds, spreads and spread comparisons from various sports betting offerings in such a way that the responses highly relevant and generated very quickly.

The platform can service a user via multiple modes of seemingly separate user interfaces (e.g., chat, web) to a same lineup or parley. For example, different modes of communications/user interfaces can be all controlled by the large language model 130 and/or the AI engine. Thus, the user can interface with the user interfaces with a natural language.

The platform can integrate AI chat, a lineup optimizer and a parlay maker such that each mode communicates with the other and is aware of changes made in the alternative mode. For example, a user can request in the chat that the platform replace a player in a lineup, and can ask the platform to make a substitution with its own AI generated recommendation or the user can request a specific substitution. In response, the platform can make the change and generate a new lineup in the chat interface; and when the user changes the interface mode to lineup optimizer the change will also be in the lineup.

An AI interface (e.g., a lineup assistant 113) implemented in a user device (e.g., 101) can be configured to implement daily fantasy and sports betting specific prompts. When such prompts are used, the platform can provide an immediate answer to a query or information that might otherwise take the user a significant amount of time to generate through a generic large language model. The creation of custom prompts combined with proprietary content feeds creates an understanding of the vocabulary (slang and traditional) for the daily fantasy and sports betting industry and the inclusion in the prompts of not just links to language answers but also mathematical and research based answers, including player comparisons, lineup generation, parlay generation, points, spreads and spread comparisons from various sports betting offerings in such a way that the responses for the user are very fast and highly accurate and relevant.

Such an AI interface can enable users to generate multiple AI generated lineups and/or parlays with different risk settings. For example, a user may want to submit multiple lineups to one daily fantasy competition hedging their position by submitting lineups generated with different risk strategies. These might include a safe strategy (e.g., the default recommendation from the platform) or a use might wish to also submit an alternate lineup with a strategy that is risky with players that have a low probability of winning but if they win generate a very large payout. The platform application enables the user to choose multiple risk strategies for lineups and sports betting parlays, generate multiple lineups and parlays, save those lineups and parlays, and monitor those lineups and parlays for changes to underlying risk factors including players, spreads, weather, injury reports, player scratching and other relevant information.

Thus, the platform can incapsulate a number of strategies to optimize a lineup that take into account: projections for players performance, ownerships, injuries and based on the distribution of outcomes from thousands of AI simulations run daily.

The platform allows a user to save: (a) chats, such as their history of chats and thereby enables them to save the AI generated content they have created through the chat; (b) lineups; and (c) parlays. For example, the platform can store generated lineups and parlays with projected scores and odds. The platform can collect all of the user chats and use them to train AI models to improve their quality.

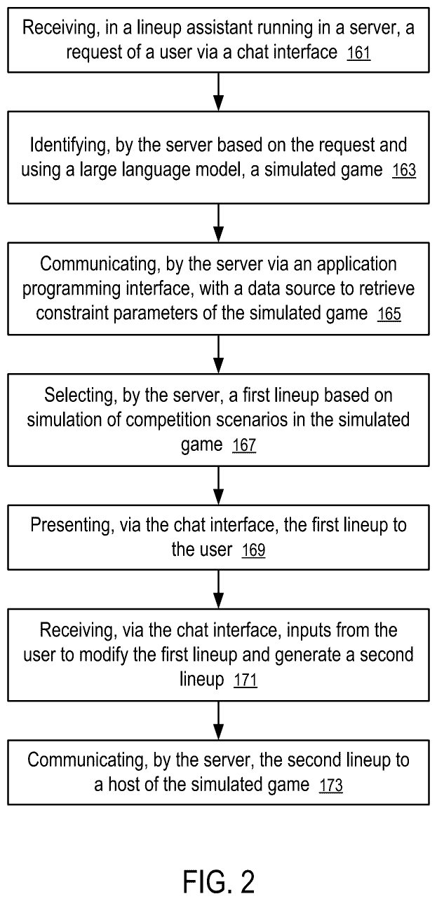

FIG. 2 shows a method implemented in an artificial intelligence platform according to one embodiment. For example, the method of FIG. 2 can be implemented in the artificial intelligence platform of FIG. 1.

At block 161, the method of FIG. 2 includes receiving, in a lineup assistant 113 running in a server 121, a request of a user via a chat interface (e.g., configured in a user device 101, 103, or 105).

At block 163, the method includes identifying, by the server 121 based on the request and using a large language model 130, a simulated game (e.g., configured in a game host 123).

At block 165, the method includes communicating, by the server 121 via an application programming interface (e.g., 151), with a data source (e.g., the game host 123, data source 141, 143, and/or 145) to retrieve constraint parameters of the simulated game.

At block 167, the method includes selecting, by the server 121, a first lineup based on simulation of competition scenarios in the simulated game.

At block 169, the method includes presenting, via the chat interface, the first lineup to the user.

At block 171, the method includes receiving, via the chat interface, inputs from the user to modify the first lineup and generate a second lineup.

At block 173, the method includes communicating, by the server 121, the second lineup to a host (e.g., 123) of the simulated game (e.g., using a game application programming interface 153).

For example, the inputs can include natural language inputs; and the large language model includes: self-attention layers 131; feed-forward layers 133; and normalization layers 135. The self-attention layers 131, the feed-forward layers 133, and the normalization layers 135 are stacked together and trained to understand the natural language inputs.

For example, the natural language inputs are received (e.g., via a user device 101, 103 or 105) as chats in text, or voice, or both. The large language model 130 is configured to train artificial neural networks using techniques of positional encoding and self-attention.

For example, the method can further include: monitoring the second lineup; detecting an event related to the second lineup; and sending a real time notification to the user.

For example, the chat interface (e.g., presented via a user device 101, 103, or 105) is configured to receive user inputs to save, edit, export, and enter lineups.

Optionally, the method of FIG. 2 can further include: applying data retrieved, responsive to the request, from the data source (e.g., the game host 123, data source 141, 143, and/or 145) as context to a call to the large language model 130.

Optionally, the method of FIG. 2 can further include: storing data identifying an account 115 of the user with the host 123 external to the server 121. The second lineup is uploaded from the server 121 into the account 115 of the user on behalf of the user.

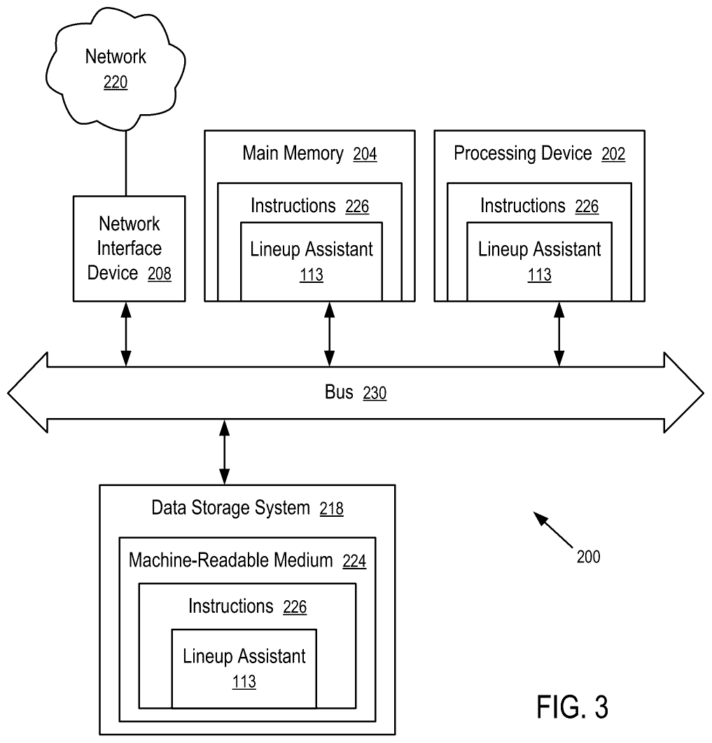

FIG. 3 illustrates an example machine of a computer system 200 within which a set of instructions, for causing the machine to perform any one or more of the methodologies discussed herein, can be executed. In some embodiments, the computer system 200 can be used to perform the operations of a lineup assistant 113 (e.g., to execute instructions to perform operations corresponding to the lineup assistant 113 described with reference to FIG. 1). In alternative embodiments, the machine can be connected (e.g., networked) to other machines in a LAN, an intranet, an extranet, and/or the internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 200 includes a processing device 202, a main memory 204 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 218, which communicate with each other via a bus 230 (which can include multiple buses).

Processing device 202 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 202 can also be one or more special-purpose processing devices such as an application specific integrated circuit (ASIC), a field programmable gate array (FPGA), a digital signal processor (DSP), network processor, or the like. The processing device 202 is configured to execute instructions 226 for performing the operations and steps discussed herein. The computer system 200 can further include a network interface device 208 to communicate over the network 220.

The data storage system 218 can include a machine-readable medium 224 (also known as a computer-readable medium) on which is stored one or more sets of instructions 226 or software embodying any one or more of the methodologies or functions described herein. The instructions 226 can also reside, completely or at least partially, within the main memory 204 and/or within the processing device 202 during execution thereof by the computer system 200, the main memory 204 and the processing device 202 also constituting machine-readable storage media. The machine-readable medium 224, data storage system 218, and/or main memory 204 can correspond to a memory sub-system.

In one embodiment, the instructions 226 include instructions to implement functionality corresponding to a lineup assistant 113 (e.g., the lineup assistant 113 described with reference to FIG. 1). While the machine-readable medium 224 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a large language model; and
a lineup assistant configured to:
receive a request of a user via a chat interface;
identify, based on the request and using the large language model, a simulated game;
communicate, via an application programming interface, with a data source to retrieve constraint parameters of the simulated game;
select a first lineup based on simulation of competition scenarios in the simulated game;
present the first lineup to the user;
receive inputs from the user to modify the first lineup and generate a second lineup; and
communicate the second lineup to a host of the simulated game.

2. The system of claim 1, wherein the inputs include natural language inputs; and
the large language model includes:
self-attention layers;
feed-forward layers; and
normalization layers;
wherein the self-attention layers, the feed-forward layers, and the normalization layers are stacked together and trained to understand the natural language inputs.

3. The system of claim 2, wherein the natural language inputs are received in the system as chats in text, or voice, or both; and
wherein the large language model is configured to train artificial neural networks using techniques of positional encoding and self-attention.

4. The system of claim 3, further comprising a server configured to run at least a portion of the lineup assistant.

5. The system of claim 4, further comprising a user interface configured to receive user inputs to save, edit, export, and enter lineups.

6. The system of claim 5, wherein the lineup assistant is configured to apply data retrieved from the data source, responsive to the request, as context to a call to the large language model.

7. The system of claim 6, wherein the server is configured to store data identifying an account of the user with the host external to the server and upload the second lineup into the account of the user on behalf of the user.

8. A method, comprising:
receiving, in a lineup assistant running in a server, a request of a user via a chat interface;
identifying, by the server based on the request and using a large language model, a simulated game;
communicating, by the server via an application programming interface, with a data source to retrieve constraint parameters of the simulated game;
selecting, by the server, a first lineup based on simulation of competition scenarios in the simulated game;
presenting, via the chat interface, the first lineup to the user;
receiving, via the chat interface, inputs from the user to modify the first lineup and generate a second lineup; and
communicating, by the server, the second lineup to a host of the simulated game.

9. The method of claim 8, wherein the inputs include natural language inputs; and
the large language model includes:
self-attention layers;
feed-forward layers; and
normalization layers; and
wherein the self-attention layers, the feed-forward layers, and the normalization layers are stacked together and trained to understand the natural language inputs.

10. The method of claim 9, wherein the natural language inputs are received as chats in text, or voice, or both; and
wherein the large language model is configured to train artificial neural networks using techniques of positional encoding and self-attention.

11. The method of claim 10, further comprising:
monitoring the second lineup;
detecting an event related to the second lineup; and
sending a real time notification to the user.

12. The method of claim 11, wherein the chat interface is configured to receive user inputs to save, edit, export, and enter lineups.

13. The method of claim 12, further comprising:
applying data retrieved, responsive to the request, from the data source as context to a call to the large language model.

14. The method of claim 13, further comprising:
storing data identifying an account of the user with the host external to the server, wherein the second lineup is uploaded from the server into the account of the user on behalf of the user.

15. A non-transitory computer storage medium storing instructions which, when executed in a computing system, cause the computing system to perform a method, comprising:
receiving, in a lineup assistant running in a server, a request of a user via a chat interface;
identifying, by the server based on the request and using a large language model, a simulated game;
communicating, by the server via an application programming interface, with a data source to retrieve constraint parameters of the simulated game;
selecting, by the server, a first lineup based on simulation of competition scenarios in the simulated game;
presenting, via the chat interface, the first lineup to the user;
receiving, via the chat interface, inputs from the user to modify the first lineup and generate a second lineup; and
communicating, by the server, the second lineup to a host of the simulated game.

16. The non-transitory computer storage medium of claim 15, wherein the inputs include natural language inputs; and the large language model includes:
self-attention layers;
feed-forward layers; and
normalization layers; and
wherein the self-attention layers, the feed-forward layers, and the normalization layers are stacked together and trained to understand the natural language inputs.

17. The non-transitory computer storage medium of claim 16, wherein the natural language inputs are received as chats in text, or voice, or both; and
wherein the large language model is configured to train artificial neural networks using techniques of positional encoding and self-attention.

18. The non-transitory computer storage medium of claim 17, wherein the chat interface is configured to receive user inputs to save, edit, export, and enter lineups.

19. The non-transitory computer storage medium of claim 18, wherein the method further comprises:
applying data retrieved, responsive to the request, from the data source as context to a call to the large language model.

20. The non-transitory computer storage medium of claim 19, wherein the method further comprises:
storing data identifying an account of the user with the host external to the server, wherein the second lineup is uploaded from the server into the account of the user on behalf of the user.
